(19) United States
(12) Patent Application Publication
(10) Pub. No.: US 2010/0060217 A1
(43) Pub. Date: Mar. 11, 2010

(54) Brushless motor starting method and control device

(75) Inventors: Tsutomu Ikeda, Tokoname-shi (JP); Takumi Kamiya, Anjo-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-shi (JP)

(21) Appl. No.: 12/461,373

(22) Filed: Aug. 10, 2009

(30) Foreign Application Priority Data
Sep. 10, 2008 (JP) 2008-232302
Mar. 24, 2009 (JP) 2009-071700

(51) Int. Cl. H02P 6/20

(52) U.S. Cl. 318/400.11; 318/400.34

(57) ABSTRACT

For starting a three-phase four-pole sensorless brushless motor including a stator having three-phase coils and a four-pole magnet rotor provided in correspondence with the stator, it is arranged to energize any two-phase coils of the three-phase coils in a predetermined energizing sequence; monitor magnetic flux generated in the other one-phase coil; and switch the two-phase coils according to a specific case where the monitored magnetic flux changes to a positive or negative side and in mid-course further changes to an opposite side. For instance, when the specific case is a case where the magnetic flux monitored by first energization changes to the negative side and in mid-course further changes to the positive side, the first energization is immediately stopped and switched to fourth energization by skipping two energizations in the predetermined energizing sequence.

### CROSS-REFERENCE TO RELATED APPLICATIONS

This application is based upon and claims the benefit of priority from the prior Japanese Patent Applications Nos. 2008-232302 filed on Sep. 10, 2008 and 2009-071700 filed on Mar. 24, 2009, the entire contents of which are incorporated herein by reference.

### TECHNICAL FIELD

The present invention relates to a brushless motor starting or activating method and a control device for starting a sensorless brushless motor.

### BACKGROUND ART

Heretofore, as a brushless motor, there has been known a brushless motor for detecting a magnetic pole position (rotor position) of a magnet rotor relative to a stator without using a sensor. Specifically, this brushless motor adopts a sensorless driving technique of performing “back electromotive force (back-EMF) drive (induction drive)” achieved by detecting voltage to be induced in a coil of the stator when the magnet rotor rotates, and generating an energization signal to a motor based on a detection signal. However, voltage is induced in the coil of the stator only during rotation of the magnet rotor. On the other hand, while the brushless motor is held stopped, the magnet rotor is not rotated, generating no back electromotive force (back-EMF) voltage (induced voltage) in the coil, and thus no information on the rotor position is obtained. At the starting of the brushless motor, therefore, “forced drive” is performed to forcibly rotate the magnet rotor, for example.

Herein, a Patent Literature listed below discloses a control method for appropriately starting a brushless motor without performing the forced drive nor rotating the brushless motor reversely. This control method for starting a three-phase four-poles brushless motor is achieved by energizing two coils for a predetermined time and then energizing one of the energized coils and a non-energized coil for a predetermined time to place a rotor of the brushless motor in a predetermined position. Specifically, in this control method, energization switching is performed twice to start the brushless motor.

### Citation List

### Patent Literature

JP 8(1996)-205579 A

### SUMMARY OF INVENTION

### Technical Problem

However, in the control method disclosed in the aforementioned Patent Literature, the two coils are energized at the starting of the brushless motor to move the rotor to a specific position, and then one of the energized coils and a non-energized coil are energized. Accordingly, a starting time is apt to become longer by the need of such two energization operations.

The present invention has been made in view of the aforementioned circumstances and has an object to provide a brushless motor starting method and a control device capable of reliably starting a brushless motor and shortening a starting time.

### Solution to Problem

To achieve the above object, according to one aspect of the present invention, there is provided a starting method for starting a three-phase four-pole sensorless brushless motor including a stator having three-phase coils and a four-pole magnet rotor provided in correspondence with the stator, the method comprising the steps of: energizing any two-phase coils of the three-phase coils in a predetermined energizing sequence for starting of the brushless motor; monitoring magnetic flux generated in the other one-phase coil; and switching energization to the two-phase coils according to a specific case where the monitored magnetic flux changes to a positive or negative side and in mid-course further changes to an opposite side.

According to another aspect, the invention provides a control device of a three-phase four-pole sensorless brushless motor including a stator having three-phase coils and a four-pole magnet rotor provided in correspondence with the stator, the device comprising: a control circuit adapted to energize any two-phase coils of the three-phase coils in a predetermined energizing sequence for starting of the brushless motor; monitor magnetic flux generated in the other one-phase coil; and switch energization to the two-phase coils according to a specific case where the monitored magnetic flux changes to a positive or negative side and in mid-course further changes to an opposite side.

According to another aspect, the invention provides a control device of a brushless motor including a stator having multiple-phase coils and a magnet rotor provided in correspondence with the stator, the device being arranged to: perform forced drive that forcibly energizes each phase coil by sequentially switching energization to each phase coil to rotate the magnet rotor; detect a position of the magnet rotor based on back-EMF voltage generated in each phase coil; and perform back-EMF drive for controlling energization to each phase coil based on a detected position, wherein the device comprises a control circuit arranged to: first start the forced drive for starting of the brushless motor; perform the back-EMF drive when the position of the magnet rotor is detected based on the back-EMF voltage within a predetermined time from the start of the forced drive; stop the forced drive when the position of the magnet rotor is not detected based on the back-EMF voltage within the predetermined time from the start of the forced drive; and execute initial setting for controlling energization to each phase coil in order to set the magnet rotor in a initial position that facilitates the starting of the magnet rotor.

### Advantageous Effects of Invention

According to the present invention, the brushless motor can be reliably started and a starting time thereof can be reduced.

### BRIEF DESCRIPTION OF DRAWINGS

FIG. 1 is an electric circuit diagram showing configurations of a brushless motor and its controller in a first embodiment;

FIG. 2 is a time chart showing each phase energization timing and variations in terminal voltage of each phase coil during back-EMF drive in the first embodiment;

FIG. 3 is a time chart showing variations in terminal voltage of each coil of a U phase, a V phase, and a W phase in the first embodiment;

FIG. 4 is a conceptual diagram showing switching between sets of energized phases and changes of a rotor position in the first embodiment;

FIG. 5 is a conceptual diagram showing switching between sets of the energized phases and changes of the rotor position in the first embodiment;

FIG. 6A is a conceptual diagram showing a “Pattern 1” for an initial position of a magnet rotor in the first embodiment;

FIG. 6B is a conceptual diagram showing a “Pattern 2” for the initial position of the magnet rotor in the first embodiment;

FIG. 6C is a conceptual diagram showing a “Pattern 3” for the initial position of the magnet rotor in the first embodiment;

FIG. 6D is a conceptual diagram showing a “Pattern 4” for the initial position of the magnet rotor in the first embodiment;

FIG. 6E is a conceptual diagram showing a “Pattern 5” for the initial position of the magnet rotor in the first embodiment;

FIG. 6F is a conceptual diagram showing a “Pattern 6” for the initial position of the magnet rotor in the first embodiment;

FIG. 7A is a conceptual diagram showing changes of the rotor position when the initial position is the “Pattern 1” in the first embodiment;

FIG. 7B is a conceptual diagram showing changes of the rotor position when the initial position is the “Pattern 1” in the first embodiment;

FIG. 8A is a graph showing changes in magnetic flux monitored in monitor phases when the initial position is the “Pattern 1” in the first embodiment;

FIG. 8B is a graph showing changes in magnetic flux monitored in monitor phases when the initial position is the “Pattern 1” in the first embodiment;

FIG. 9 is a conceptual diagram showing changes of the rotor position when the initial position is a “Pattern 1-1” in the first embodiment;

FIG. 10 is a graph showing changes in magnetic flux monitored in monitor phases when the initial position is a “Pattern 1-1” in the first embodiment;

FIG. 11 is a conceptual diagram showing changes of the rotor position when the initial position is a “Pattern 2” in the first embodiment;

FIG. 12 is a graph showing changes in magnetic flux monitored in monitor phases when the initial position is a “Pattern 2” in the first embodiment;

FIG. 13 is a conceptual diagram showing changes of the rotor position when the initial position is a “Pattern 3” in the first embodiment;

FIG. 14 is a graph showing changes in magnetic flux monitored in monitor phases while the initial position is a “Pattern 3” in the first embodiment;

FIG. 15 is a conceptual diagram showing changes of the rotor position when the initial position is a “Pattern 4” in the first embodiment;

FIG. 16 is a graph showing changes in magnetic flux monitored in monitor phases while the initial position is a “Pattern 4” in the first embodiment;

FIG. 17 is a conceptual diagram showing changes of the rotor position when the initial position is a “Pattern 5” in the first embodiment;

FIG. 18 is a graph showing changes in magnetic flux monitored in monitor phases when the initial position is a “Pattern 5” in the first embodiment;

FIG. 19 is a conceptual diagram showing changes of the rotor position when the initial position is a “Pattern 6” in the first embodiment;

FIG. 20 is a graph showing changes in magnetic flux monitored in monitor phases when the initial position is a “Pattern 6” in the first embodiment;

FIG. 21 is a flowchart showing control logic of starting control in the first embodiment;

FIG. 22 is a graph showing changes in magnetic flux monitored in monitor phases when the initial position is the “Pattern 1” in the first embodiment;

FIG. 23 is a conceptual diagram showing changes of the rotor position when the initial position is the “Pattern 1” in the first embodiment;

FIG. 24 is a graph showing changes in magnetic flux monitored in monitor phases when the initial position is the “Pattern 6” in the first embodiment;

FIG. 25 is a conceptual diagram showing changes of the rotor position when the initial position is the “Pattern 6” in the first embodiment;

FIG. 26 is a graph showing changes in magnetic flux monitored in monitor phases when the initial position is the “Pattern 1-1” in the first embodiment;

FIG. 27 is a conceptual diagram showing changes of the rotor position when the initial position is the “Pattern 1-1” in the first embodiment;

FIG. 28 is a flowchart showing control logic of starting control in a second embodiment;

FIG. 29 is a flowchart showing control logic of starting control in a third embodiment;

FIG. 30 is a flowchart showing control logic of starting control in a fourth embodiment; and

FIG. 31 is a flowchart showing control logic of starting control in a fifth embodiment.

### DESCRIPTION OF EMBODIMENTS

### First Embodiment

A detailed description of a preferred embodiment of a brushless motor starting method and a control device embodying the present invention will now be given referring to an accompanying drawing.

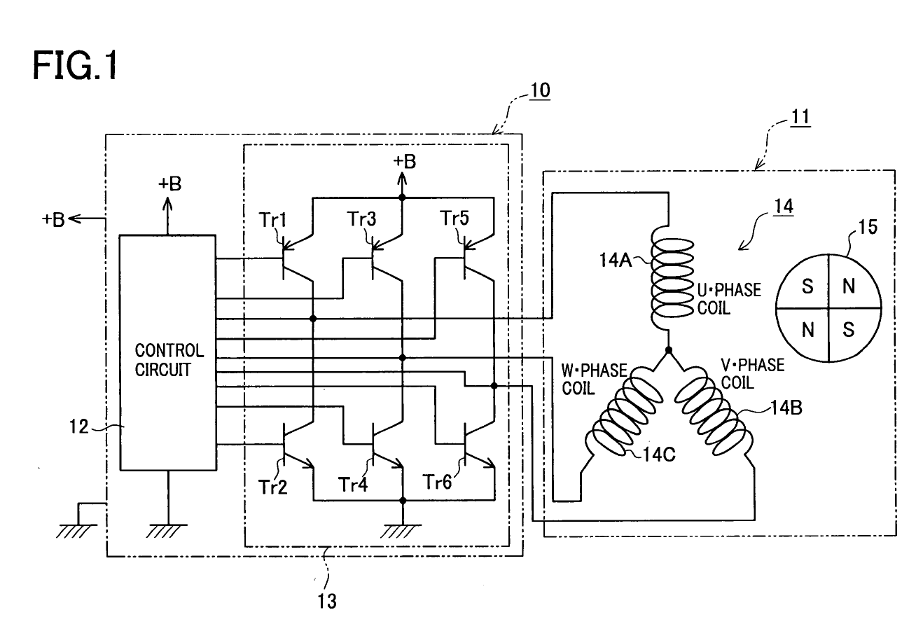

This embodiment is explained about a brushless motor starting method and a control device to be used in a water pump or a fuel pump for a cooling device of an engine. FIG. 1 is an electric circuit diagram showing configurations of a brushless motor 11 and a controller 10 thereof to be used in the water pump or the fuel pump. The controller 10 includes a control circuit 12 and a drive circuit 13. In this embodiment, the brushless motor 11 is a sensorless, three-phase four-pole motor adopting a three-phase full-wave drive circuit as the drive circuit 13. The brushless motor 11 comprises a stator 14 including three-phase (a U phase, a V phase, and a W phase) coils 14A, 14B, and 14C, and a four-pole magnet rotor 15. The brushless motor 11 is the sensorless type and hence utilizes back electromotive force (back-EMF) voltage (induced voltage) generated in each phase coil 14A to 14C of the stator 14 to detect a magnetic pole position (rotor position) of the magnet rotor 15 relative to the stator 14 without using a hall element. Then, when the magnet rotor 15 rotates, “back electromotive force (back-EMF) drive (induction drive)” is performed by detecting the rotor position based on the back-EMF voltage generated in each phase coil 14A to 14C, and selecting ones of the coils 14A to 14C to be energized based on the rotor position detected.

As shown in FIG. 1, the drive circuit 13 is constituted by first, third, and fifth transistors Tr1, Tr3, and Tr5 of PNP type as switching elements and second, fourth, and sixth transistors Tr2, Tr4, and Tr6 of NPN type as switching elements, which are connected in three-phase bridge configuration. The first, third, and fifth transistors Tr1, Tr3, and Tr5 have emitters which are connected respectively to a power supply terminal (+B), while the second, fourth, and sixth transistors Tr2, Tr4, and Tr6 have emitters which are grounded respectively. The each phase coils 14A, 14B, and 14C have, at one ends, a common terminal to which all of the phase coils are connected. At the other ends, the U phase coil 14A has a terminal connected to a common connection point of the first and second transistors Tr1 and Tr2, the W phase coil 14C has a terminal connected to a common connection point of the third and fourth transistors Tr3 and Tr4, and the V phase coil 14B has a terminal connected to a common connection point of the fifth and sixth transistors Tr5 and Tr6. Each base of the transistors Tr1 to Tr6 is connected to the control circuit 12. One terminal of the control circuit 12 is connected to the power supply terminal (+B) and the other terminal thereof is grounded. The control circuit 12 in this embodiment is constituted by a custom IC.

The brushless motor 11 in this embodiment is a sensorless type and hence no back-EMF voltage is generated in the coils 14A to 14C while the brushless motor 11 is stopped. In this embodiment, therefore, for starting of the brushless motor 11, the “back-EMF drive” is performed by forcibly energizing two phases of the three-phase coils 14A to 14C in a predetermined energizing sequence, thereby rotating the magnet rotor 15. However, even if each coil 14A to 14C is forcibly energized in the predetermined energizing sequence by disregarding the rotor position during starting, the magnet rotor 15 may be rotated or not rotated. Thus, the brushless motor 11 could be started or not started and it would take longer time than necessary before completion of starting. In this embodiment, therefore, predetermined “starting control” is performed to start the brushless motor 11 to switch energization to each phase coil 14A to 14C, thereby starting the brushless motor 11. After desired back-EMF voltage is generated by this “starting control”, the “forced drive” is switched to the aforementioned “back-EMF drive”.

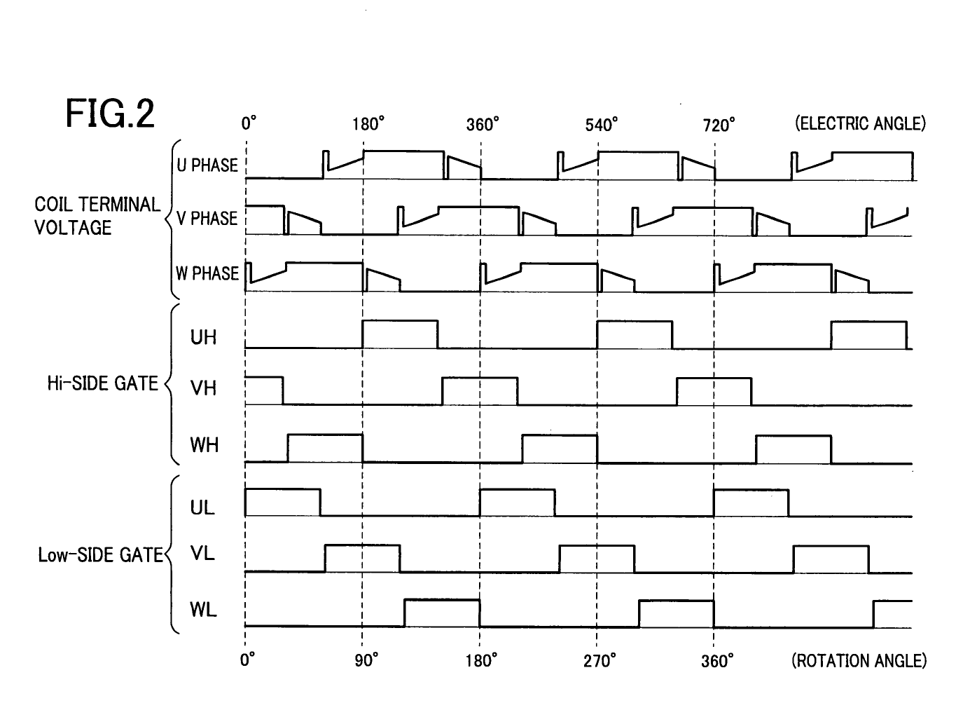

The details of the “back-EMF drive” are explained below. FIG. 2 is a time chart showing energization timing of each phase to be carried out by the control circuit 12 during the back-EMF drive and variations in voltage of each phase coil terminal. The control circuit 12 controls energization to each base (gate) of the transistors Tr1 to Tr6 of the drive circuit 13 to control energization to the coils 14A to 14C of the U phase, V phase, and W phase. In FIG. 2, the words “UH, VH, WH” indicate a Hi-side gate for setting the U, V, and W phases at a high level and the words “UL, VL, WL” indicate a Low-side gate for setting the U, V, and W phases at a low level. As shown in FIG. 2, when energization of the Hi-side gate and the Low-side gate is controlled, the coils 14A to 14C of the U to W phases are energized selectively, generating coil terminal voltage in each coil 14A to 14C.

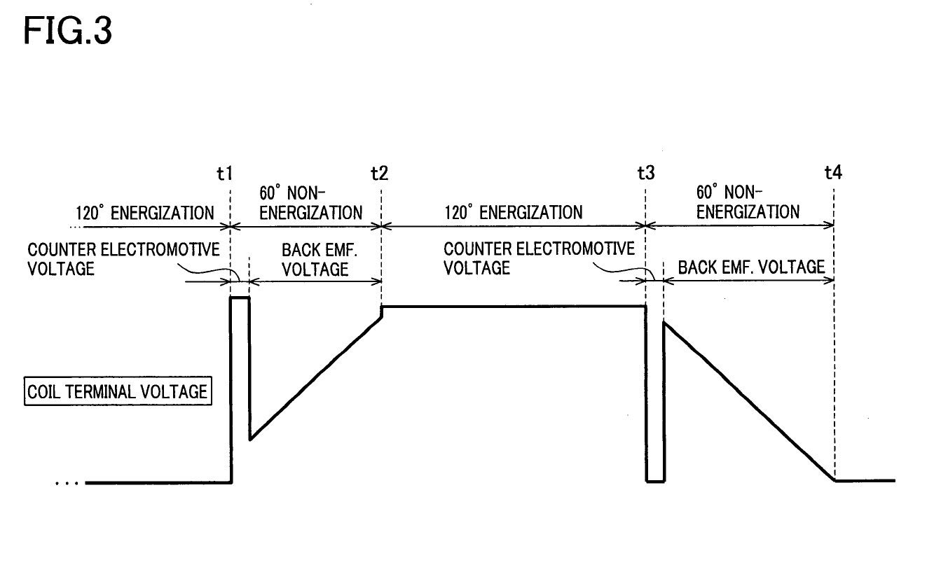

FIG. 3 is a time chart showing variations in terminal voltage of each phase coil 14A to 14C of the U phase, V phase, and W phase. As is found from this chart, each phase coil 14A to 14C is subjected to “120° energization” and “60° non-energization” alternately. In FIG. 3, when the coil is switched to a non-energized state at time t1, a positive counter electromotive force is first generated as pulse-shaped voltage and subsequently back-EMF voltage increases. During a period from switching to energization at time t2 up to switching to non-energization at time t3, the voltage stays positive at a constant level. When the coil is switched to a non-energized state at time t3, a negative counter electromotive force is generated as pulse-shaped voltage and subsequently back-EMF voltage decreases. When the coil is switched to the energized state at time t4, the voltage stays negative at a constant level. The control circuit 12 detects the rotor position by utilizing the back-EMF voltage generated following the counter electromotive voltage. The control circuit 12 controls energization to each phase coil 14A to 14C of the U, V, and W phases based on the rotor position detected as above. Specifically, the control circuit 12 causes the magnet rotor 15 to rotate by sequentially switching energization to each phase coil 14A to 14C of the U to W phases of the stator 15. The control circuit 12 further detects the rotor position based on the back-EMF voltage generated in each phase coil 14A to 14C. The control circuit 12 then controls the energization to each phase coil 14A to 14C based on the detected rotor position.

As above, the back-EMF drive control is performed.

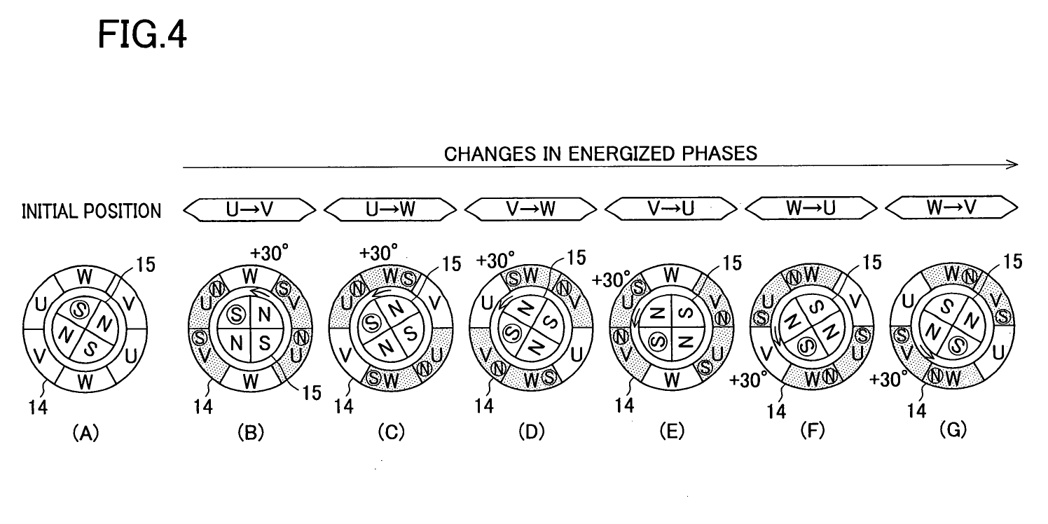

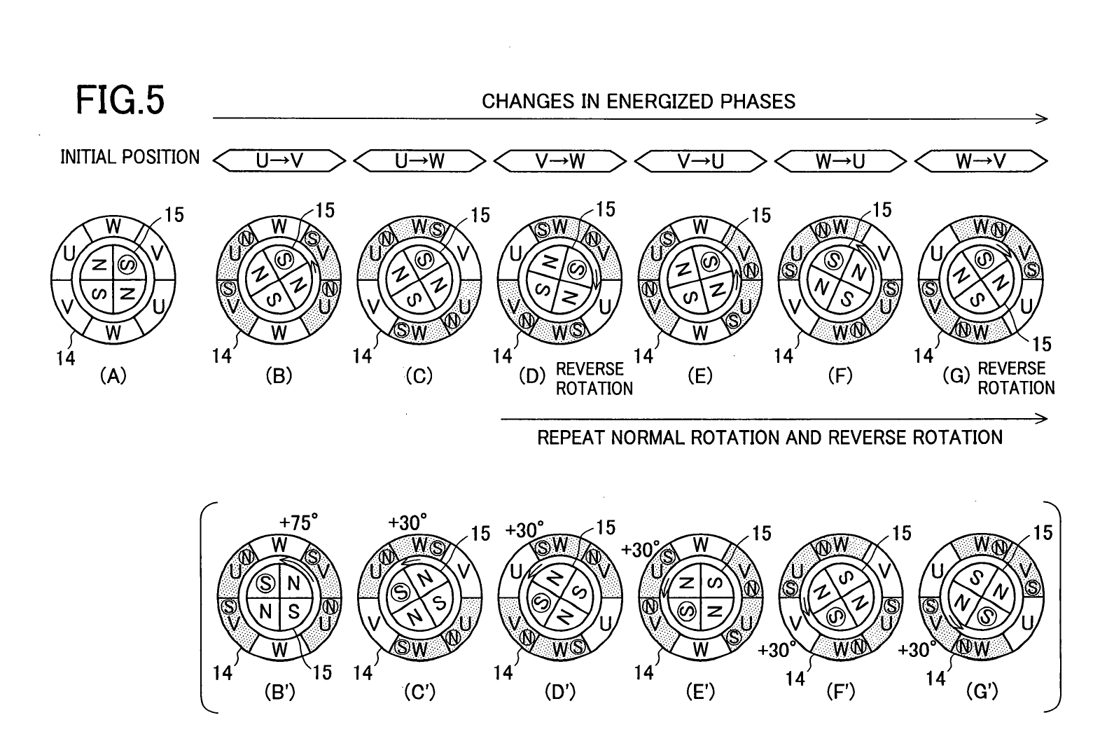

FIG. 4 is a conceptual diagram showing switching between sets of energized phases and changes of a magnetic pole position (rotor position) of the magnet rotor 15 relative to the stator 14 in the case where a stop position (an initial position) of the magnet rotor 15 relative to the stator 14 is suitable for starting the brushless motor 11. FIG. 5 is a conceptual diagram showing switching between the sets of the energized phases and changes of the magnetic pole position (rotor position) of the magnet rotor 15 relative to the stator 14 in the case where the stop position (initial position) of the magnet rotor 15 relative to the stator 14 is not suitable for starting the brushless motor 11. In this embodiment, as shown in FIGS. 4 and 5, the sets of the energized phases are switched in a predetermined energizing sequence; “U→V”, “U→W”, “V→W”, “V→U”, “W→U”, and “W→V” to drive the brushless motor 11. When the brushless motor 1 is in a stop state and the magnet rotor 15 is in an initial position relative to the stator 14 as shown in (A) in FIG. 4, the energized phases are switched sequentially in the above energizing sequence as shown in (B) to (G) in FIG. 4, thereby normally rotating the magnet rotor 15. Thus, the brushless motor 11 can be started. On the other hand, when the brushless motor 1 is in a stop state and the magnet rotor 15 is in an initial position relative to the stator 14 as shown in (A) in FIG. 5, in the energized phases “U→V” as shown in (B) in FIG. 5, the energized phases are switched before the magnet rotor 15 completes the rotation. In the energized phases “U→W” as shown in (C) in FIG. 5, the magnet rotor 15 is attracted in a reverse rotating direction by switching between the sets of the energized phases and hence the magnet rotor 15 is stopped. Subsequently, therefore, the energized phases are switched in the above energizing sequence as shown in (D) to (G) in FIG. 5, thereby repeating the normal rotation and the reverse rotation of the magnet rotor 15. Thus, the brushless motor 11 cannot be started. In this regard, even if the magnet rotor 15 is in the initial position as shown in (A) in FIG. 5, if inertia moment of the magnet rotor 15 is small or starting torque is small, the energized phases are switched in the above energizing sequence as shown in (B′) to (G′) in FIG. 5, thereby normally rotating the magnet rotor 15. Thus, the brushless motor 11 can be started. In this way, depending on the initial position of the magnet rotor 15, the brushless motor 11 can or cannot be started and hence the brushless motor could not be reliably started conventionally.

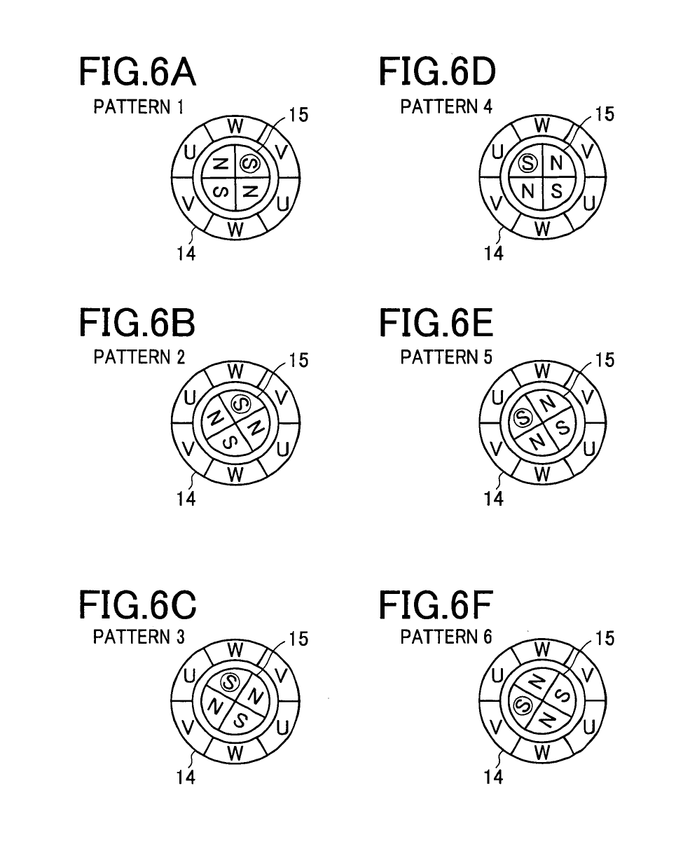

In this embodiment, therefore, all of the initial positions of the magnet rotor 15 are checked and the energization to each phase coil 14A to 14C is appropriately controlled in correspondence with all of the initial positions so that the brushless motor 11 is started. Herein, FIGS. 6A to 6F are conceptual diagrams showing all conceivable patterns (Pattern 1 to Pattern 6) of the initial positions of the magnet rotor 15. As shown in FIGS. 6A to 6F, there are six patterns as the initial positions; “Pattern 1” to “Pattern 6”. Regarding all of these initial positions, it was checked whether or not the brushless motor 11 could be started.

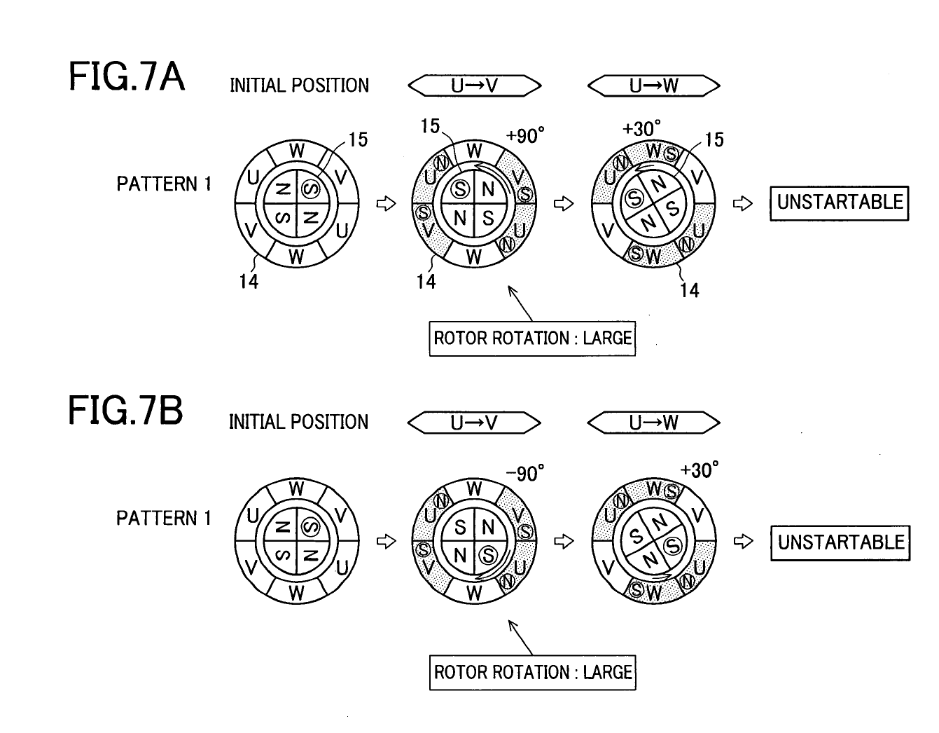

FIGS. 7A and 7B are conceptual diagrams showing magnetic pole positions of the magnet rotor 15 relative to the stator 14, i.e., the rotor positions, when the set of the energized phases is switched from “U→V” to “U→W” in the case where the initial position is “Pattern 1” in FIG. 6A. In this case, as shown in FIG. 7A, one behavior is assumed that the magnet rotor 15 normally rotates 90° during the first energization and normally rotates 30° during second energization. At that time, the rotation angle (absolute value) during the first energization is so large and the rotation of the magnet rotor 15 cannot follow the switching between the sets of the energized phases. Thus, the brushless motor 11 cannot be started. On the other hand, as shown in FIG. 7B, another behavior is assumed that the magnet rotor 15 reversely rotates 90° during first energization and normally rotates 30° during second energization. At that time, the rotation angle (absolute value) during the first energization is so large and the rotation of the magnet rotor 15 cannot follow the switching between the sets of the energized phases. Thus, the brushless motor 11 cannot be started.

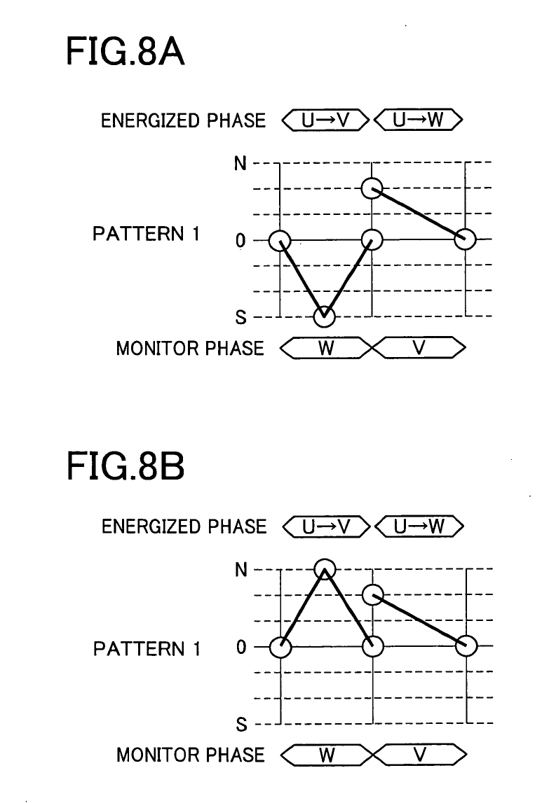

FIGS. 8A and 8B are graphs showing, in the case of the above “Pattern 1”, changes in magnetic flux monitored in the subject monitor phase which is the one other than the energized phases. FIG. 8A corresponds to FIG. 7A and FIG. 8B corresponds to FIG. 7B. As shown in FIGS. 8A and 8B, the W phase is the monitor phase in the energized phases (U→V) for first energization and the V phase is the monitor phase in the energized phases (U→W) for second energization. Herein, for example, in the energized phases (U→V) for first energization, the rotation of the magnet rotor 15 causes the magnetic flux to occur in the W phase coil 14C in which no current flows. Thus, back-EMF voltage is generated by the change in the magnetic flux. This back-EMF voltage is outputted as positive and negative voltages in correspondence with positive and negative changes in magnetic flux. Thus, behaviors of rotation (rotating direction) of the magnet rotor 15 can be recognized. The same applies to the energized phases (U→W) for second energization. It is found from FIG. 8A that the magnetic flux changes to an S side in the energized phases (U→V) for first energization and in mid-course changes to an N side, and further the magnetic flux changes to the S side in the energized phases (U→W) for second energization. It is found from FIG. 8B that the magnetic flux changes to the N side in the energized phases (U→V) for first energization and in mid-course changes to the S side, and further the magnetic flux changes to the S side in the energized phases for second energization. Since the change in magnetic flux is directed to the opposite side during the first energization, it is assumed that the rotation of the magnet rotor 15 cannot follow the switching between the sets of the energized phases.

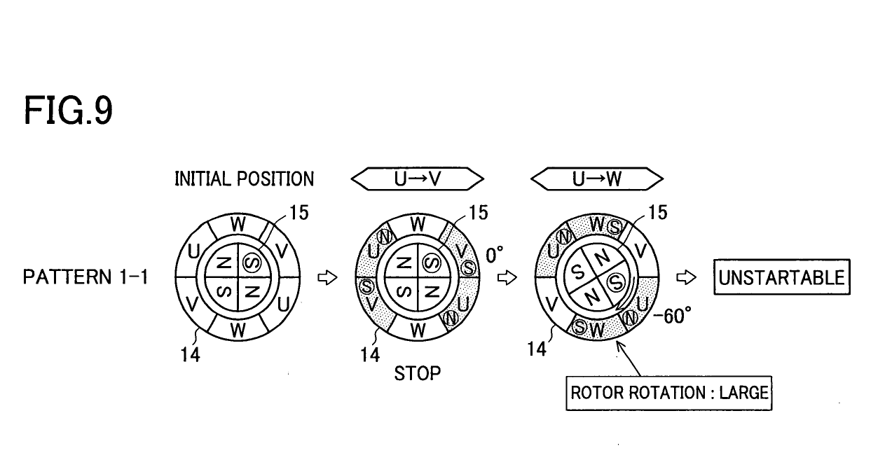

FIG. 9 is a conceptual diagram showing changes of the rotor position when the set of the energized phases is switched from “U→V” to “U→W” in the case where the initial position is “Pattern 1-1”. This initial position “Pattern 1-1” is equal to “Pattern 1” but different therefrom in the behavior of the magnet rotor 15. In this case, the magnet rotor 15 does not rotate during the first energization and reversely rotates 60° during the second energization. The rotation angle (absolute value) during the second energization is so large and hence the rotation of the magnet rotor 15 cannot follow the switching between the sets of the energized phases. Thus, the brushless motor 11 cannot be started.

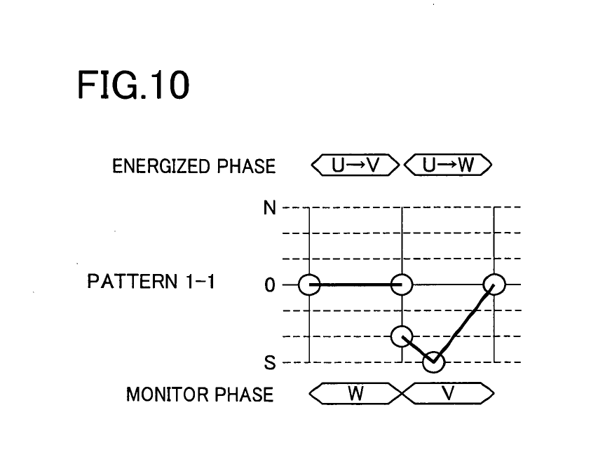

FIG. 10 is a graph showing changes in the magnetic flux monitored in the monitor phase in the case of the above “Pattern 1-1”. It is found from FIG. 10 that the magnetic flux remains unchanged in the energized phases (U→V) for first energization but changes to the S side in the energized phases (U→W) for second energization and in mid-course further changes to the N side. Since the change in magnetic flux is directed to the opposite side during the second energization in this way, it is assumed that the rotation of the magnet rotor 15 cannot follow the switching between the sets of the energized phases.

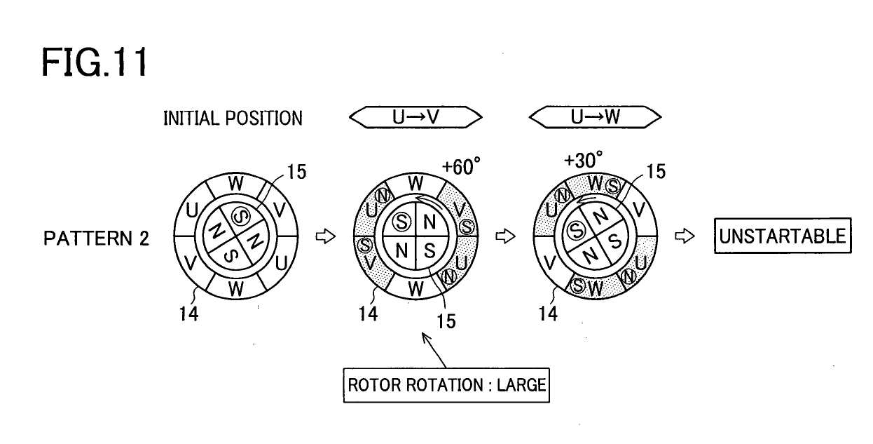

FIG. 11 is a conceptual diagram showing changes of the rotor position when the set of the energized phases is switched from “U→V” to “U→W” in the case where the initial position is “Pattern 2” in FIG. 6B. In this case, the magnet rotor 15 normally rotates 60° during the first energization and further normally rotates 30° during the second energization. The rotation angle (absolute value) during the first energization is as large as 60° and the rotation of the magnet rotor 15 cannot follow the switching between the sets of the energized phases. Thus, the brushless motor 11 cannot be started.

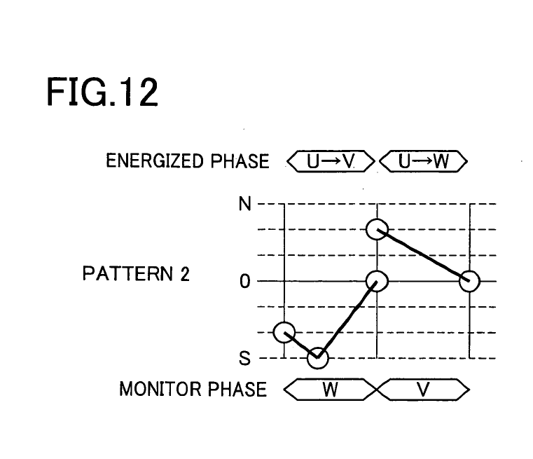

FIG. 12 is a graph showing changes in the magnetic flux monitored in the monitor phase in the case of the above “Pattern 2”. It is found from FIG. 12 that the magnetic flux changes to the S side and in mid-course changes to the N side in the energized phases (U→V) for first energization, and the magnetic flux changes to the S side in the energized phases (U→W) for second energization. Since the changes in magnetic flux are directed to the opposite side during the first energization in this way, it is assumed that the rotation of the magnet rotor 15 cannot follow the switching between the sets of the energized phases.

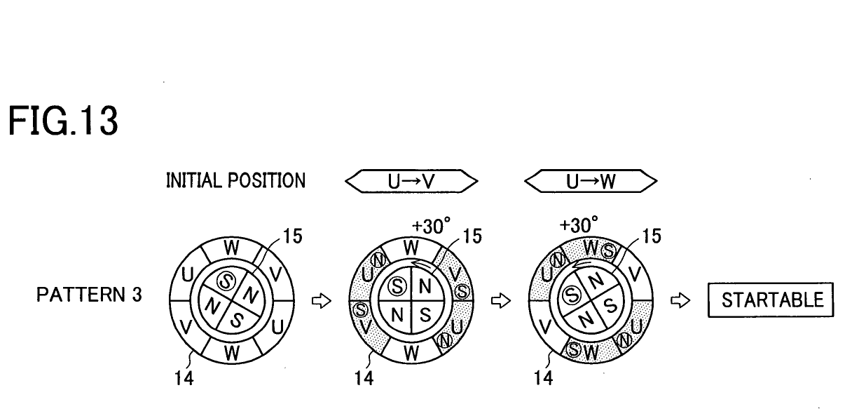

FIG. 13 is a conceptual diagram showing changes of the rotor position when the set of the energized phases is switched from “U→V” to “U→W” in the case where the initial position is “Pattern 3” in FIG. 6C. In this case, the magnet rotor 15 normally rotates 30° during the first energization and further normally rotates 30° during the second energization. The rotation angle (absolute value) during the first energization and the rotation angle (absolute value) during the second energization are as small as 30° and the rotation of the magnet rotor 15 can follow the switching between the sets of the energized phases. Thus, the brushless motor 11 can be started.

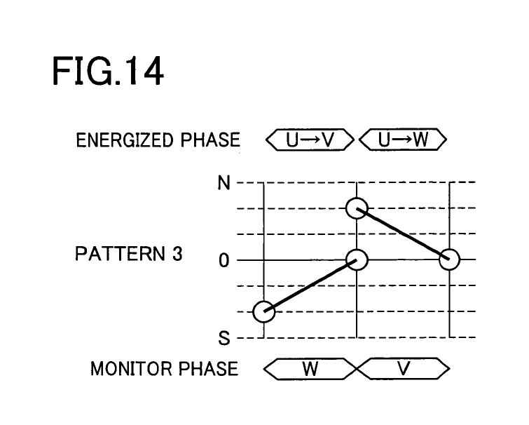

FIG. 14 is a graph showing changes in the magnetic flux monitored in the monitor phase in the case of the above “Pattern 3”. It is found from FIG. 14 that the magnetic flux changes to the N side in the energized phases (U→V) for first energization and the magnetic flux changes to the S side in the energized phases (U→W) for second energization. Since the changes in magnetic flux are not directed to the opposite side during both of the first and second energization operations in this way, it is assumed that the rotation of the magnet rotor 15 can follow the switching between the sets of the energized phases.

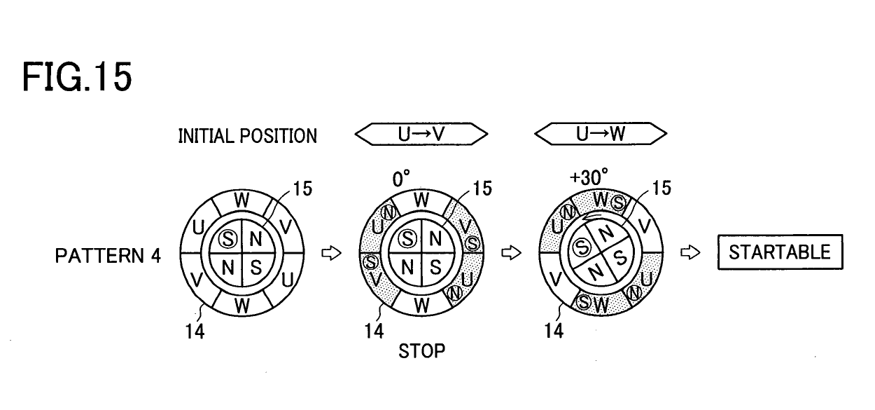

FIG. 15 is a conceptual diagram showing changes of the rotor position when the set of the energized phases is switched from “U→V” to “U→W” in the case where the initial position is “Pattern 4” in FIG. 6D. In this case, the magnet rotor 15 does not rotate during the first energization and normally rotates 30° during the second energization. The rotation angle (absolute value) during the first energization and the rotation angle (absolute value) during the second energization are as small as 0° or 30° and the rotation of the magnet rotor 15 can follow the switching between the sets of the energized phases. Thus, the brushless motor 11 can be started.

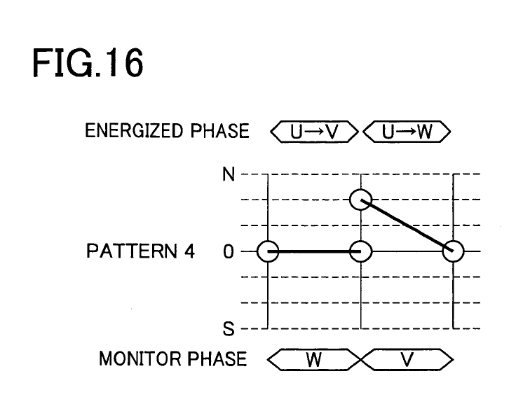

FIG. 16 is a graph showing changes in the magnetic flux monitored in the monitor phases in the case of the above “Pattern 4”. It is found from FIG. 16 that the magnetic flux does not change in the energized phases (U→V) for first energization and the magnetic flux changes to the S side in the energized phases (U→W) for second energization. Since the changes in magnetic flux are not directed to the opposite side during both of the first and second energization operations, it is assumed that the rotation of the magnet rotor 15 can follow the switching between the sets of the energized phases.

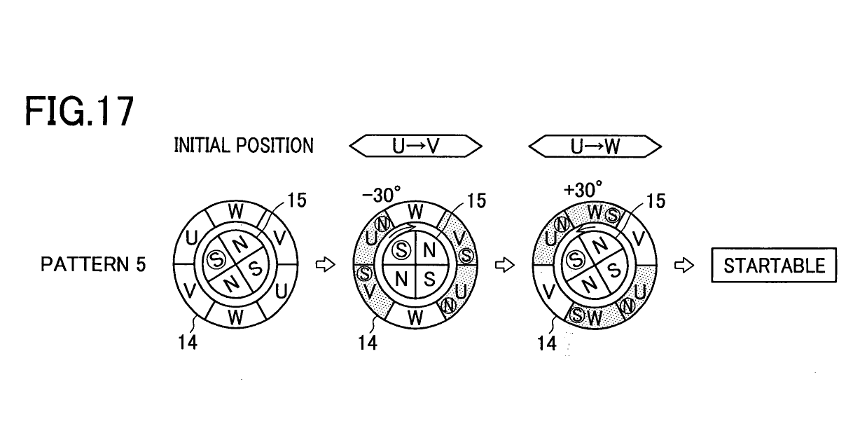

FIG. 17 is a conceptual diagram showing changes of the rotor position when the set of the energized phases is switched from “U→V” to “U→W” in the case where the initial position is “Pattern 5” in FIG. 6E. In this case, the magnet rotor 15 reversely rotates 30° during the first energization and normally rotates 30° during the second energization. The rotation angle (absolute value) during the first energization and the rotation angle (absolute value) during the second energization are as small as 30° and the rotation of the magnet rotor 15 can follow the switching between the sets of the energized phases. Thus, the brushless motor 11 can be started.

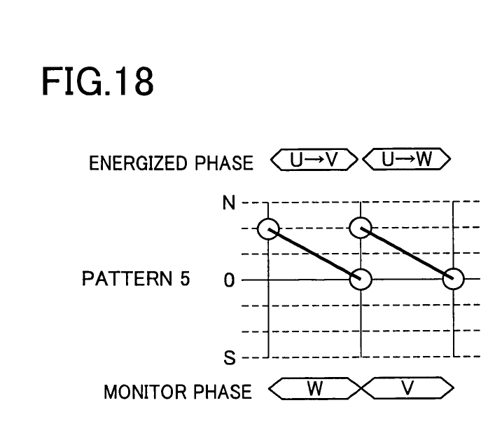

FIG. 18 is a graph showing changes in the magnetic flux monitored in the monitor phases in the case of the above “Pattern 5”. It is found from FIG. 18 that the magnetic flux changes to the S side in the energized phases (U→V) for first energization and also changes to the S side in the energized phases (U→W) for second energization. Since the changes in magnetic flux are not directed to the opposite side during both of the first and second energizations, it is assumed that the rotation of the magnet rotor 15 can follow the switching between the sets of the energized phases.

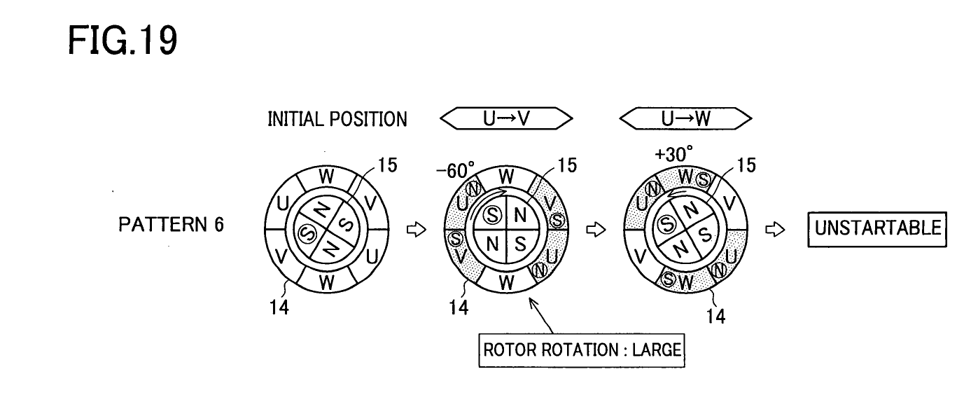

FIG. 19 is a conceptual diagram showing changes of the rotor position when the set of the energized phases is switched from “U→V” to “U→W” in the case where the initial position is “Pattern 6” in FIG. 6F. In this case, as shown in FIG. 19, one behavior is assumed that the magnet rotor 15 reversely rotates 60° during the first energization and normally rotates 30° during the second energization. At that time, the rotation angle (absolute value) during the first energization is so large and the rotation of the magnet rotor 15 cannot follow the switching between the sets of the energized phases. Thus, the brushless motor 11 cannot be started.

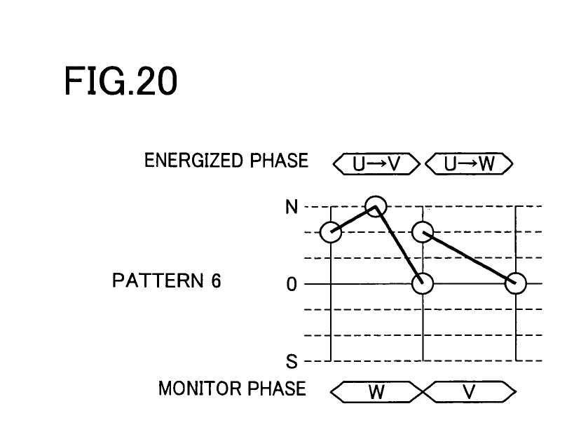

FIG. 20 is a graph showing, in the case of the above “Pattern 6”, changes in magnetic flux monitored in the subject monitor phases. FIG. 20 corresponds to FIG. 19. It is found from FIG. 20 that the magnetic flux changes to the N side in the energized phases (U→V) for first energization and in mid-course changes to the S side in mid-course, and the magnetic flux changes to the S side in the energized phases (U→W) for second energization. Since the changes in magnetic flux are directed to the opposite side during the first energization, it is assumed that the rotation of the magnet rotor 15 cannot follow the switching between the sets of the energized phases.

As a result of the above checks, it is found that the brushless motor 11 cannot be started in the cases where the initial position is “Pattern 1”, “Pattern 1-1”, “Pattern 2”, and “Pattern 6”, and the common reason thereof is in that the magnetic flux changes to the opposite side in mid-course of the first or second energization. In this embodiment, therefore, the “starting control” for starting the brushless motor 11 from all of the initial positions is performed by detecting the position where the magnet rotor 15 cannot follow the switching between the sets of the energized phases, that is, the position where the magnetic flux changes to the opposite side in mid-course during energization, and switching the energized phases at that time.

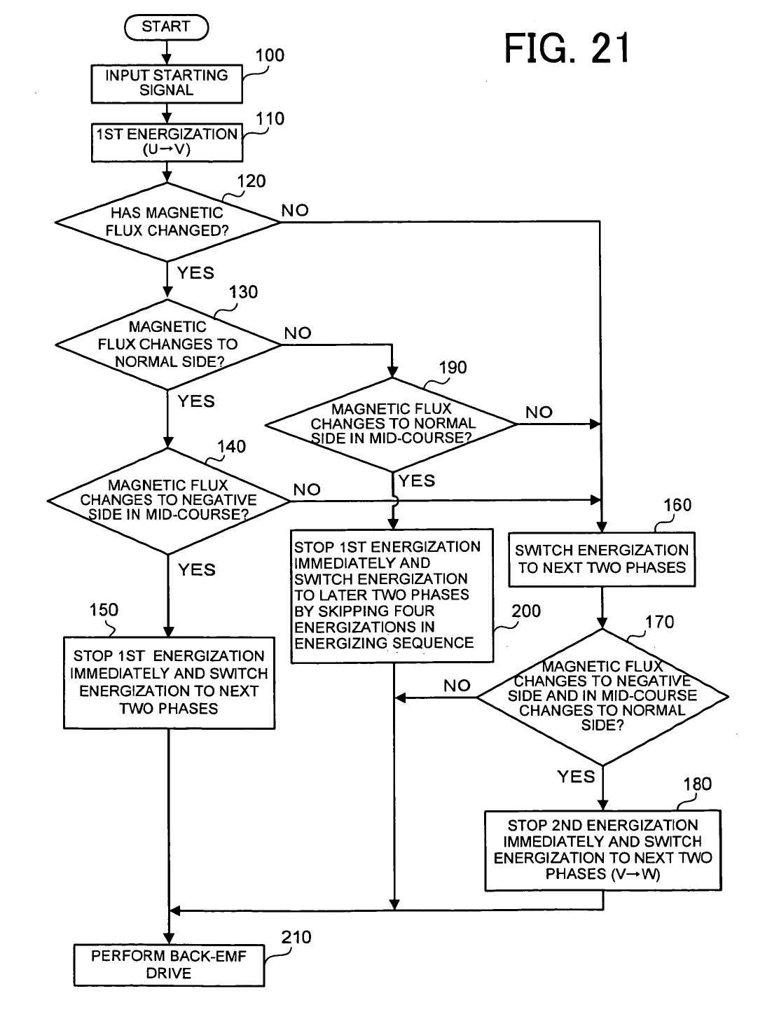

FIG. 21 is a flowchart of control logic of the “starting control” to be performed by the control circuit 12. In this control logic, when a start signal is input in step 100 by turn-on of an ignition switch of an engine, the control circuit 12 performs first energization to the coils 14A and 14B of two phases (U→V) in step 110.

In step 120, successively, the control circuit 12 determines whether or not the magnetic flux has been changed by the above energization. In this case, the change of magnetic flux generated in the W phase coil 14C is determined by taking the W phase as the monitor phase. If this determination result is affirmative, the control circuit 12 advances the process to step 130. If negative, the control circuit 12 advances the process to step 160.

In step 130 following step 120, the control circuit 12 determines whether or not the magnetic flux has changed to a positive side (N side). If this determination result is affirmative, the control circuit 12 advances the process to step 140. If negative, the control circuit 12 advances the process to step 190.

In step 140 following step 130, the control circuit 12 determines whether or not the magnetic flux has changed to a negative side (S side) in mid-course. If this determination result is affirmative, the control circuit 12 immediately stops energization to the two phases (U→V) for first energization in step 150 and switches to energization to the two phases (U→W) for second energization. Subsequently, the control circuit 12 advances the process to step 210. On the other hand, if a determination result in step 140 is negative, the control circuit 12 advances the process to step 160.

On the other hand, in step 160 following step 120 or 140, the control circuit 12 switches to energization to next two phases (U→W). Then, the control circuit 12 advances the process to step 170.

In step 170, the control circuit 12 determines whether or not the magnetic flux has changed to the negative side (S side) and, in mid-course, changed to the positive side (N side). If this determination result is affirmative, the control circuit 12 immediately stops energization to the two phases (U→W) for second energization and switches to energization to next two phases (V→W) for third energization in step 180. The control circuit 12 then advances the process to step 210. If a determination result in step 170 is negative, the control circuit 12 advances the process to step 210.

On the other hand, in step 190 following step 130, the control circuit 12 determines whether or not the magnetic flux has changed to the positive side (N side) in mid-course. If a determination result is affirmative, the control circuit 12, in step 200, immediately stops energization to the two phases (U→V) for first energization and switches to energization to two phases (W→V) for sixth energization by skipping four energizations (four sets of energized phases) in the energizing sequence. The control circuit 12 then advances the process to step 210. If a determination result in step 190 is negative, the control circuit 12 shifts the process to step 160.

In step 210 following step 150, 170, 180, or 200, the control circuit 12 performs the back-EMF drive.

In this embodiment, as mentioned above, for starting of the brushless motor 11, two-phase coils of three-phase coils 14A to 14C are energized and the magnetic flux generated in the other one-phase coil is monitored. In a specific case where the monitored magnetic flux changes to the positive or negative side and in mid-course changes to the opposite side, energization to two-phase coils is switched according to the specific case.

Herein, if the above specific case is the case where the magnetic flux monitored by first energization changes to the negative side (S side) and in mid-course changes to the positive side, energization to the coils 14A and 14B of the two phases (U→V) for first energization is immediately stopped and energization is switched to the coils 14C and 14B of the two phases (W→V) for later sixth energization by skipping four energizations (four sets of energized phases) in the predetermined energizing sequence. This is the starting method corresponding to the case where the initial position of the magnet rotor 15 is the “Pattern 1” and “Pattern 2” whereby the brushless motor could not be started conventionally.

Furthermore, if the above specific case is the case where the magnetic flux monitored by first energization changes to the positive side (N side) and in mid-course further changes to the negative side (S side), the first energization to the coils 14A and 14B of the two phases (U→V) is immediately stopped and switched to the coils 14A and 14C of next two phases (U→W) for second energization in the energizing sequence. This is the starting method corresponding to the case where the initial position of the magnet rotor 15 is the “Pattern 6” whereby the brushless motor could not be started conventionally.

If the above specific case is the case where the magnetic flux monitored by the first energization remains unchanged and then energization is applied to the coils 14A and 14C of next two phases (U→W) for second energization in the energizing sequence and the magnetic flux changes to the negative side (S side) and in mid-course further changes to the positive side (N side), the second energization is immediately stopped and switched to the coils 14B and 14C of next two phases (V→W) for third energization in the energizing sequence. This is the starting method corresponding to the case where the initial position of the magnet rotor 15 is the “Pattern 1-1” whereby the brushless motor could not be started conventionally.

In this embodiment, furthermore, if the magnetic flux monitored during the first energization is unchanged or if the magnetic flux is not changed in mid-course, the control circuit 12 switches to energization to next two phases (U→W) and then shifts to the back-EMF drive. This is the starting method corresponding to the case where the initial position of the magnet rotor 15 is the “Pattern 3 to Pattern 5” whereby the brushless motor could be started conventionally.

According to the starting method and control device of the brushless motor 11 in this embodiment, as explained above, there is a specific case where any two-phase coils of the three-phase coils 14A to 14C are energized in the predetermined energizing sequence for starting of the brushless motor 11, and the magnetic flux generated in the other one-phase coil changes to the positive or negative side and in mid-course further changes to the opposite side. In this specific case, it is confirmed that the magnet rotor 15 is stopped in the initial position that makes the magnet rotor 15 hard to rotate due to a relation with the stator 14, the rotation of the magnet rotor 15 cannot follow the switching between the sets of the energized phases, and the brushless motor 11 cannot be started. At the stop of the three-phase four-pole brushless motor 11, it is confirmed that six patterns of “Patterns 1 to 6” as shown in FIGS. 6A to 6F are present and, the brushless motor cannot be started in two of the patterns, that is, “Patterns 1, 2, and 6”. Accordingly, the energization to two-phase coils is switched according to the aforementioned specific case, so that the rotation of the magnet rotor 15 can easily follow the switching between the sets of the energized phases. Therefore, the brushless motor 11 can be always reliably started and the starting time (period) thereof can be shortened.

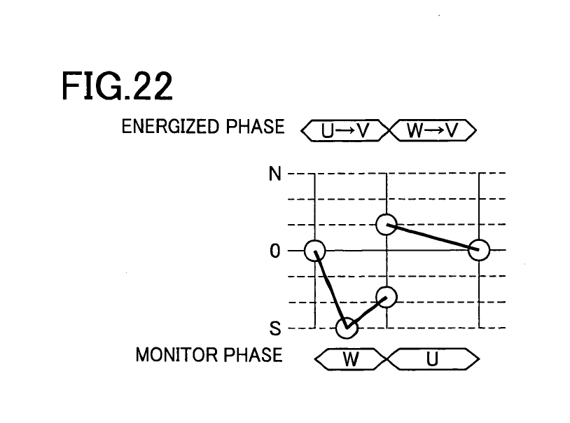

Herein, a concrete explanation is given below to the results of the above starting method implemented in the case where the initial position of the magnet rotor 15 is “Pattern 1”. FIG. 22 is a graph showing changes in magnetic flux monitored in the W phase coil 14C serving as the monitor phase in the case of “Pattern 1”. In this embodiment, during energization to the coils 14A and 14B of two phases (U→V) for first energization, when the magnetic flux monitored in the monitor phase changes to the negative side (S side) and in mid-course further changes to the positive side (N side), the first energization to the coils 14A and 14B of the two phases (U→V) is immediately stopped and switched to the coils 14C and 14B of two phases (W→V) for later sixth energization by skipping four energizations (four sets of energized phases) in the energizing sequence. In this second energization, the magnetic flux changes to the negative side (S side).

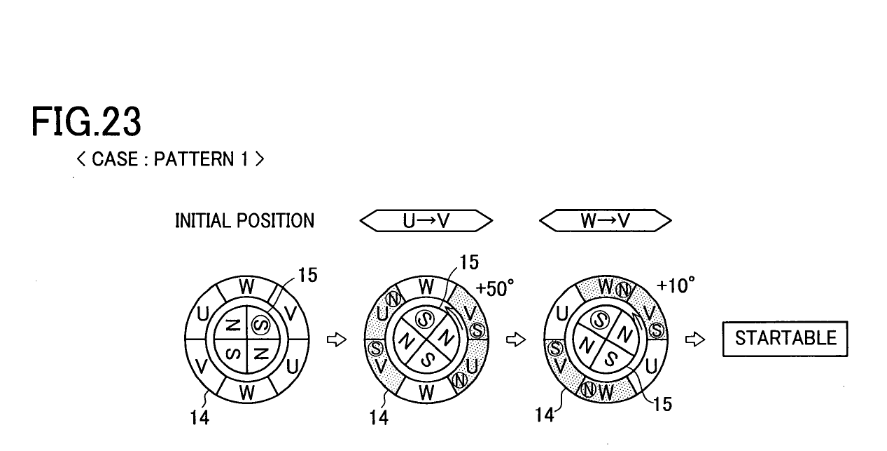

FIG. 23 is a conceptual diagram showing changes of the rotor position as a result of the starting method corresponding to the case where the initial position of the magnet rotor 15 is the “Pattern 1”. In the above case, the magnet rotor 15 normally rotates 50° during energization to two phases (U→V) for first energization and normally rotates 10° during energization to two phases (W→V) for second energization. A difference between the rotation angle (absolute value) during the first energization and the rotation angle (absolute value) during the second energization is as relatively small as 40° and the rotation of the magnet rotor 15 can follow the switching between the sets of the energized phases. Thus, the brushless motor 11 can be started.

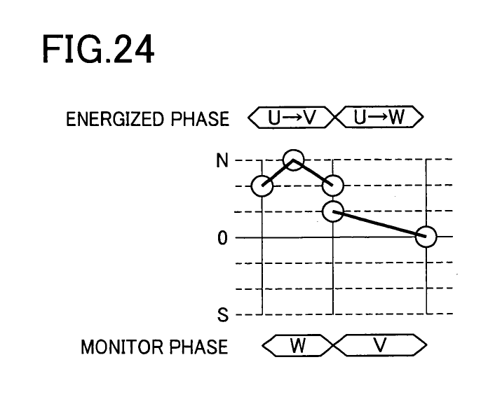

Next, a concrete explanation is given below to the results of the above starting method implemented in the case where the initial position of the magnet rotor 15 is “Pattern 6”. FIG. 24 is a graph showing changes in magnetic flux monitored in the W phase coil 14C and the V phase coil 14B serving as the monitor phases in the case of “Pattern 6”. In this embodiment, during energization to the coils 14A and 14B of two phases (U→V) for first energization, when the magnetic flux monitored in the monitor phase changes to the positive side (N side) and in mid-course further changes to the negative side (S side), energization to two phases (U→V) for first energization is immediately stopped and switched to the coils 14A and 14C of next two phases (U→W) for second energization in the energizing sequence. In this second energization, the magnetic flux is unchanged.

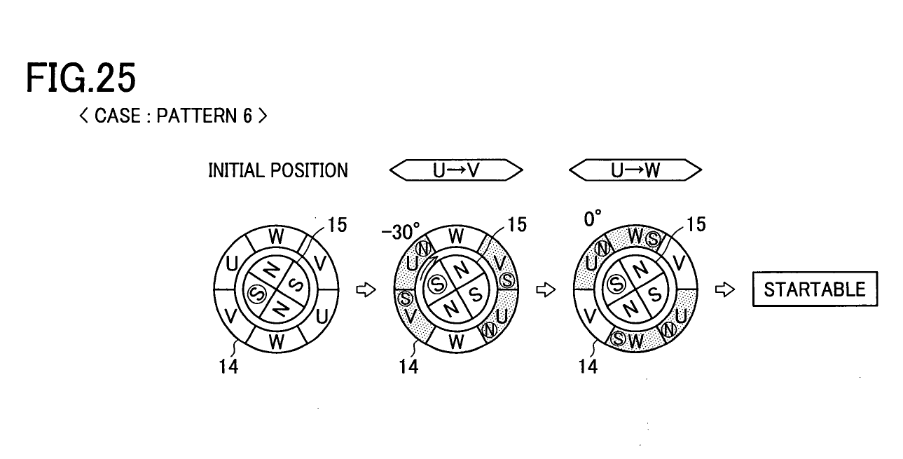

FIG. 25 is a conceptual diagram showing changes of the rotor position as a result of the starting method corresponding to the case where the initial position of the magnet rotor 15 is the “Pattern 6”. In the above case, the magnet rotor 15 reversely rotates 30° during energization to two phases (U→V) for first energization and does not rotate (0°) during energization to two phases (V→U) for second energization. A difference between the rotation angle (absolute value) during the first energization and the rotation angle (absolute value) during the second energization is as relatively small as 30° and the rotation of the magnet rotor 15 can follow the switching between the sets of the energized phases. Thus, the brushless motor 11 can be started.

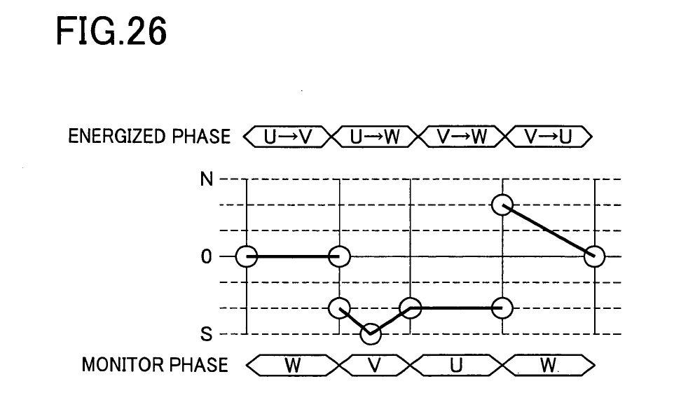

Next, a concrete explanation is given below to the results of the above starting method implemented in the case where the initial position of the magnet rotor 15 is “Pattern 1-1”. FIG. 26 is a graph showing changes in magnetic flux monitored in each phase coil 14A to 14C serving as the monitor phase. In this embodiment, during energization to the coils 14A and 14B of two phases (U→V) for first energization, the magnetic flux monitored in the monitor phase is unchanged. In the energization to the coils 14A and 14C of next two phases (U→W) for second energization in the energizing sequence, when the magnetic flux changes to the negative side (S side) and in mid-course changes to the positive side (N side), the second energization is immediately stopped and switched to the coils 14B and 14C of next two phases (V→W) for third energization in the energizing sequence. Then, the energization is switched to the coils 14A and 14B of next two phases (V→U) for fourth energization in the energizing sequence. In the third energization, the magnetic flux is unchanged. In the fourth energization, the magnetic flux changes to the S side.

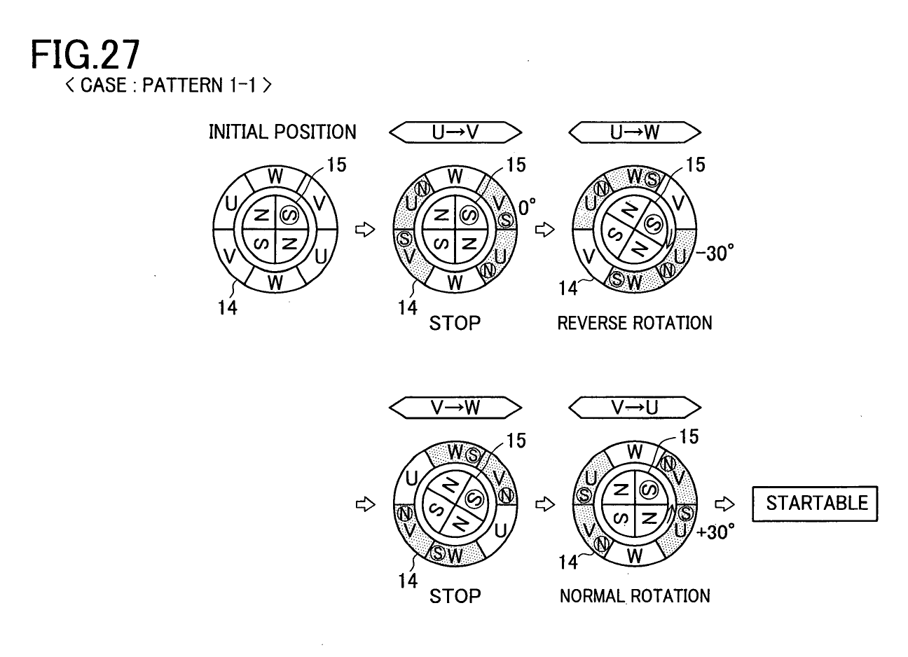

FIG. 27 is a conceptual diagram showing changes of the rotor position as a result of the starting method corresponding to the case where the initial position of the magnet rotor 15 is the “Pattern 1-1”. In the above case, the magnet rotor 15 does not rotate during energization to two phases (U→V) for first energization and reversely rotates 30° during energization to two phases (U→W) for second energization. Herein, a difference between the rotation angle (absolute value) during the first energization and the rotation angle (absolute value) during the second energization is as relatively small as 30°. Then, the magnet rotor 15 is stopped during energization to two phases (V→W) for third energization and normally rotates 30° during energization to two phases (V→U) for fourth energization. Herein, a difference between the rotation angle (absolute value) during the third energization and the rotation angle (absolute value) during the fourth energization is as relatively small as 30°. In this way, the magnet rotor 15 can follow the switching between the sets of the energized phases. Thus, the brushless motor 11 can be started.

In this embodiment, when the magnetic flux monitored is unchanged during energization to two phases (U→V) for first energization, the energization is switched to next two phases (U→W) and then shifted to the back-EMF drive. Accordingly, the rotation of the magnet rotor 15 can follow the switching between the sets of the energized phases in correspondence with four initial positions of “Patterns 2 to 5” (see FIGS. 6B to 6E) that facilitate starting of the brushless motor 11, of the six initial positions thereof. Therefore, in the case of the “Patterns 2 to 5” that facilitate starting of the brushless motor 11, the motor 11 can be started reliably.

### Second Embodiment

Next, a second embodiment of the control device of the brushless motor according to the present invention will be explained below in detail referring to an accompanying drawing.

In the following explanations, the same or similar components or parts to those in the first embodiment are given the same reference signs and their details are not explained below. The following explanations are focused on differences from the first embodiment.

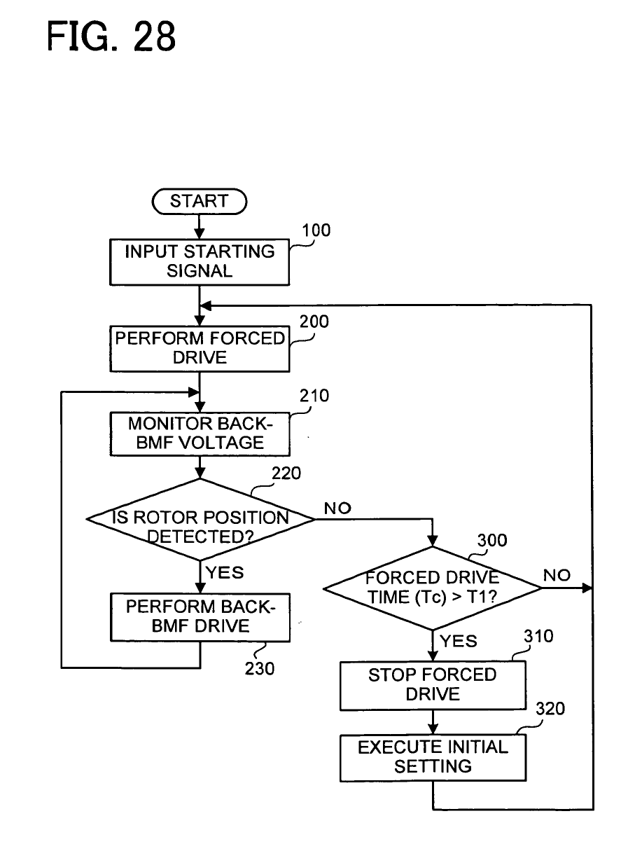

This embodiment differs from the first embodiment in the details of the control logic of the “starting control” to be performed by the control circuit 12. FIG. 28 is a flowchart of the control logic.

In this control logic, as in the first embodiment, when a start signal is input in step 100 by turn-on of an ignition switch of an engine, the control circuit 12 performs the “forced drive” in step 200. Specifically, in this embodiment, each phase coil 14A to 14C is forcibly energized in an energizing sequence of a series of “U→V”, “U→W”, “V→W”, “V→U”, “W→U”, and “W→V” to start the brushless motor 11.

Successively, the control circuit 12 monitors in step 210 the back-EMF voltage generated in each phase coil 14A to 14C and determines in step 220 whether or not the magnetic pole position (rotor position) of the magnet rotor 15 is detected based on the back-EMF voltage. If this determination result is affirmative, the control circuit 12 performs in step 230 the “back-EMF drive” and repeats the processes in steps 210 to 230. The details of the “back-EMF drive” are the same as those explained in the first embodiment. After completion of the starting of the brushless motor 11 as above, a series of the processes in steps 210 to 230 is performed to thereby continue the back-EMF drive of the brushless motor 11.

If a determination result in step 220 is negative, on the other hand, the control circuit 12 performs the processes in steps 300 to 320. Specifically, in step 300, it is determined whether or not a time (forced drive time) Tc for which the forced drive is continued is longer than a predetermined time T1. Herein, for example, the predetermined time T1 may be set to “50 to 200 (ms)”. If a determination result in step 300 is negative, the control circuit 12 returns the process to step 200 and repeats the processes in step 200 and subsequent steps.

If a determination result in step 300 is affirmative, the control circuit 12 stops the forced drive in step 310. In step 320, the control circuit 12 then executes “initial setting”. Specifically, the control circuit 12 sets the magnet rotor 15 in a position that facilitates starting of the magnet rotor 15. In this case, for example, the control circuit 12 performs energization from the W phase to the V phase in each phase coil 14A to 14C. The control circuit 12 then returns the process to step 200 and repeats the processes in step 200 and subsequent steps.

Herein, to facilitate starting of the brushless motor 11, it is conceivable that the initial setting for controlling energization to each phase coil 14A to 14C to set the magnet rotor 15 yet to be started to the initial position that facilitates starting is performed before the forced drive and the back-EMF drive. Even though the initial setting is not need to be executed when the magnet rotor 15 is initially in the initial position, if the initial setting is executed every time before the forced drive and the back-EMF drive are performed, the starting time of the brushless motor 11 is likely to become longer by such unnecessary initial setting.

According to the control device in this embodiment, on the other hand, the control circuit 12 first starts the forced drive for starting of the brushless motor 11. If the position of the magnet rotor 15 can be detected based on back-EMF voltage after start of the forced drive and before a lapse of the predetermined time Tc, the back-EMF drive is performed. If the position of the magnet rotor 15 cannot be detected based on back-EMF voltage after start of the forced drive and before a lapse of the predetermined time Tc, the forced drive is stopped and the initial setting is executed, and the forced drive is restarted. Accordingly, if the back-EMF drive can be performed only by the forced drive for starting of the brushless motor 11, the initial setting is not needed to be executed. This makes it possible to shorten the starting time by just that the initial setting is not executed every time. Only if the back-EMF drive cannot be performed by the forced drive, the initial setting is executed and the forced drive is restarted. Thus, the brushless motor can be started reliably. According to this embodiment, it is possible to reliably start the brushless motor 11 and shorten the starting time thereof.

### Third Embodiment

A third embodiment of the control device of the brushless motor according to the present invention will be explained below in detail referring to an accompanying drawing.

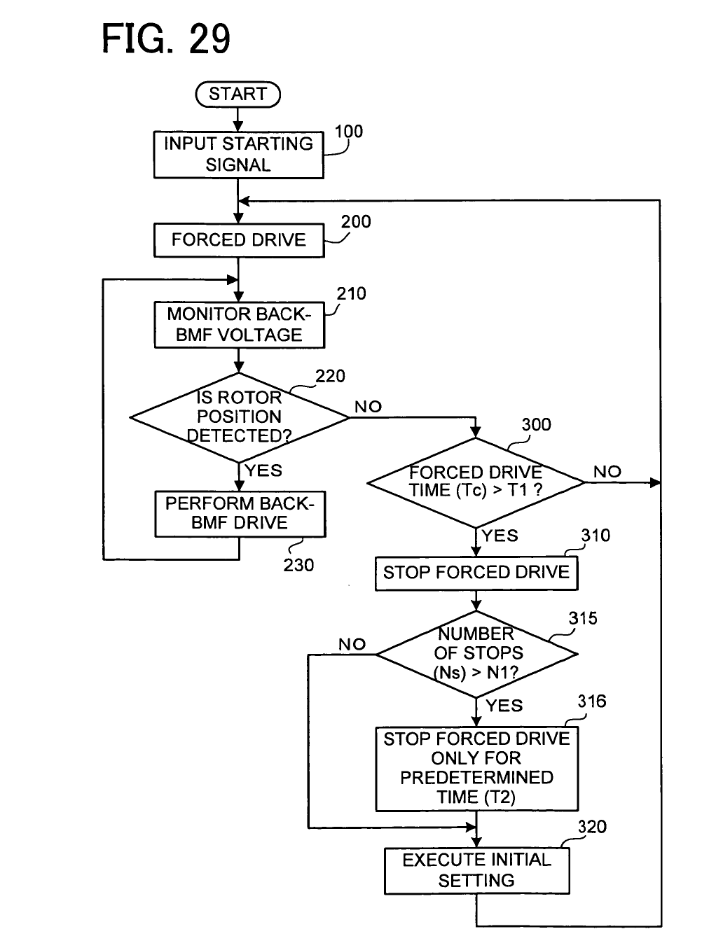

This embodiment is different from the first and second embodiments in the details of the control logic of the “starting control” to be performed by the control circuit 12. FIG. 29 is a flowchart of the control logic.

This control logic is different in configuration from that of the second embodiment in that the processes in steps 315 and 316 related to stop of the forced drive are added between steps 310 and 320.

Specifically, the control circuit 12 stops the forced drive in step 310 and then determines in step 315 whether or not the number Ns of stops of forced drive is larger than a predetermined number N1. Herein, the predetermined number N1 may be set to for example “5”. If a determination result in step 315 is negative, the control circuit 12 directly advances the process to step 320 and executes the initial setting.

If the determination result in step 315 is affirmative, the control circuit 12 stops the forced drive only for a predetermined time T2 in step 316 and then advances the process to step 320 to execute the initial setting. Herein, the predetermined time T2 may be set to for example “30 seconds”. In other words, repeating start and stop of the forced drive may cause the brushless motor 11 and the drive circuit 13 to generate heat and get damage. In step 316, therefore, the forced drive is stopped only for the predetermined time T2 so that the drive circuit 13 and others are not operated and thus are cooled.

In the control device in this embodiment explained above, if the back-EMF drive cannot be performed after the forced drive, it is conceivable that the magnet rotor 15 is in a locked state. In this embodiment, therefore, if the back-EMF drive cannot be performed after the forced drive, start and stop of the forced drive are repeated by the predetermined number N1, thereby removing foreign matters or the like which cause the magnet rotor 15 to be locked. If the number Ns of stops of the forced drive exceeds the predetermined number N1, the forced drive can be interrupted only for the predetermined time T2 before the initial setting is executed, thereby preventing damages to the drive circuit 13 and others due to heat generation thereof. The other operations and effects are substantially the same as those in the second embodiment.

### Fourth Embodiment

A fourth embodiment of the control device of the brushless motor according to the present invention will be explained below in detail referring to an accompanying drawing.

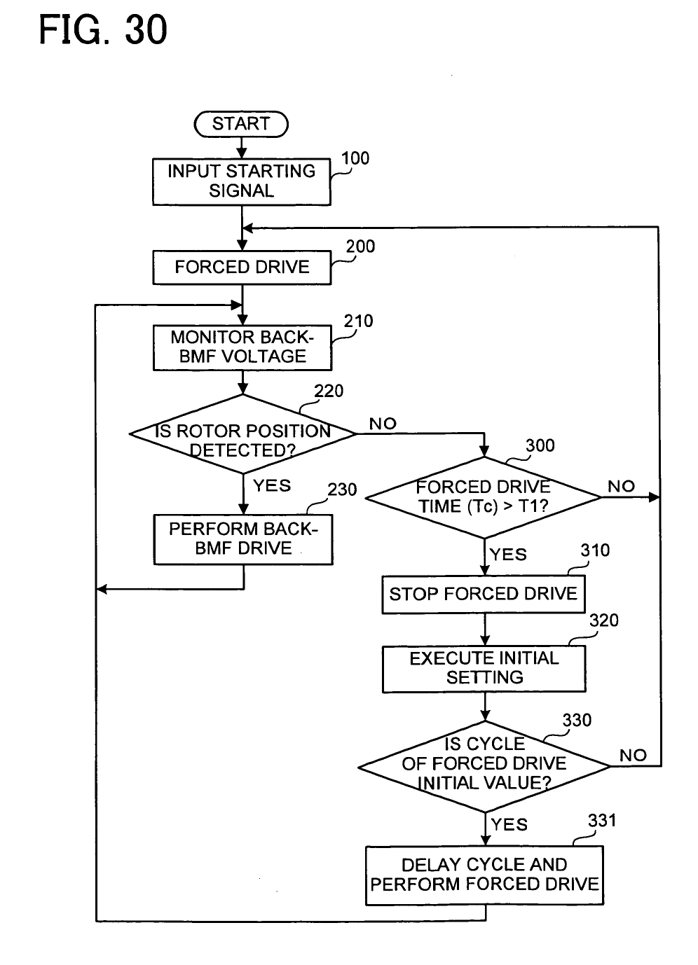

This embodiment differs from the first to third embodiments in the details of the control logic of the “starting control” to be performed by the control circuit 12. FIG. 30 is a flowchart of the control logic.

This control logic differs in configuration from the first embodiment in that the processes in steps 330 and 331 related to a cycle of the forced drive are added after step 320.

Specifically, the control circuit 12 executes the initial setting in step 320 and determines in step 330 whether or not the cycle of the forced drive is an initial value. Herein, the cycle of the forced drive corresponds to a time interval between a previous time and a current time for energization to each phase coil 14A to 14C only for the predetermined time to perform the forced drive. If a determination result in step 330 is negative, the control circuit 12 directly advances the process to step 200 to perform the forced drive.

If the determination result in step 330 is affirmative, on the other hand, the control circuit 12 performs the forced drive by delaying the cycle in step 331 and shifts the process to step 210 to monitor the back-EMF voltage. In other words, when the forced drive is repeated after the initial setting, the cycle of the forced drive is delayed by assuming that a load during the starting becomes heavy.

In the control device mentioned above, if the cycle of the forced drive after the initial setting is the initial value, the load during starting is considered heavy and accordingly the cycle of the forced drive is delayed. This makes it possible to forcibly drive the brushless motor 11 irrespective of changes in load during starting, thereby leading to the back-EMF drive.

### Fifth Embodiment

A fifth embodiment of the control device of the brushless motor according to the present invention will be explained below in detail referring to an accompanying drawing.

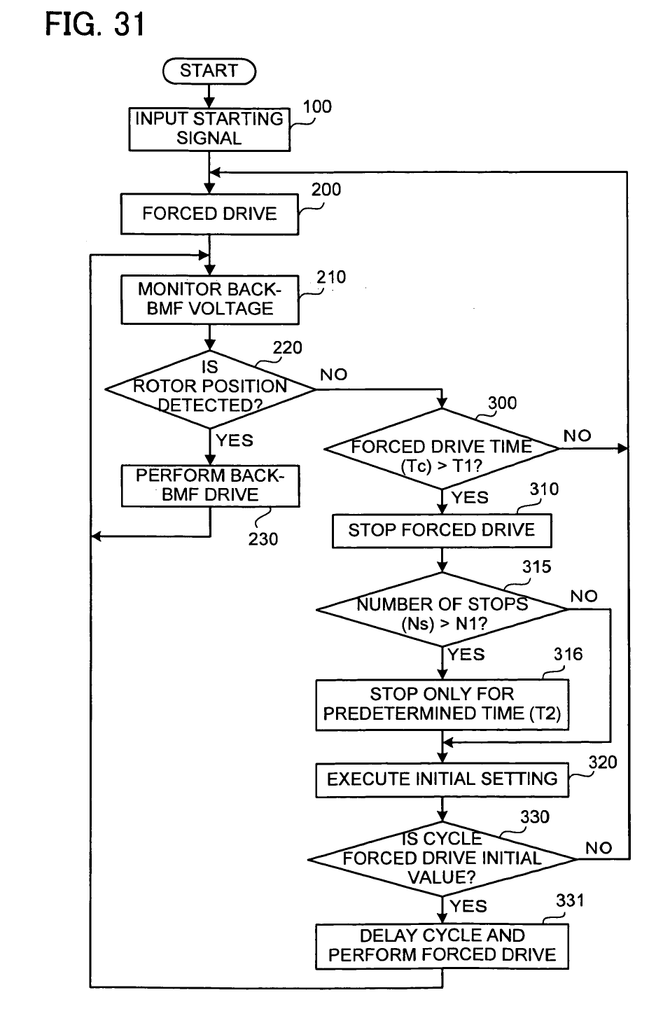

This embodiment differs from the first to fourth embodiments in the details of the control logic of the “starting control” to be performed by the control circuit 12. FIG. 31 is a flowchart of the control logic.

This control logic differs from that in the fourth embodiment in that the processes in steps 315 and 316 related to stop of the forced drive are added between the steps 310 and 320. The details of the processes in steps 315 and 316 are the same as in the third embodiment and thus are not explained here.

According to the control device in this embodiment, therefore, besides the operations and effects of the control device in the fourth embodiment, when the back-EMF drive cannot be performed after the forced drive, start and stop of the forced drive are repeated by the predetermined time N1, thereby eliminating foreign matters and others which cause the magnet rotor 15 to be locked. When the number Ns of stops of the forced drive exceeds the predetermined number N, the forced drive can be interrupted only for the predetermined time T2 before the initial setting is executed. This makes it possible to prevent damages to the drive circuit 13 and others due to heat generation.

The present invention is not limited to each of the aforementioned embodiments and may be embodied in other specific forms without departing from the spirit or essential characteristics thereof.

### INDUSTRIAL APPLICABILITY

The present invention can be utilized in a fuel pump, a water pump, etc. to be used for a vehicle engine.

While the presently preferred embodiment of the present invention has been shown and described, it is to be understood that this disclosure is for the purpose of illustration and that various changes and modifications may be made without departing from the scope of the invention as set forth in the appended claims.

### REFERENCE SIGNS LIST

11 Brushless motor
12 Control circuit
13 Drive circuit
14 Stator
14A Coil (U phase)
14B Coil (V phase)
14C Coil (W phase)
15 Magnet rotor

1. A starting method for starting a three-phase four-pole sensorless brushless motor including a stator having three-phase coils and a four-pole magnet rotor provided in correspondence with the stator, the method comprising the steps of:
energizing any two-phase coils of the three-phase coils in a predetermined energizing sequence for starting of the brushless motor;
monitoring magnetic flux generated in the other one-phase coil; and
switching energization to the two-phase coils according to a specific case where the monitored magnetic flux changes to a positive or negative side and in mid-course further changes to an opposite side.

2. The starting method of the brushless motor according to claim 1, wherein
when the specific case is a case where the magnetic flux monitored by first energization changes to the negative side and in mid-course changes to the positive side, the first energization is immediately stopped and switched to sixth energization by skipping four energizations in the predetermined energizing sequence.

3. The starting method of a brushless motor according to claim 1, wherein
when the specific case is a case where the magnetic flux monitored by first energization changes to the positive side and in mid-course further changes to the negative side, the first energization is immediately stopped and switched to second energization.

4. The starting method of the brushless motor according to claim 1, wherein
when the specific case is a case where the magnetic flux monitored by first energization remains unchanged, changes to the negative side by second energization and in mid-course further changes to the positive side, the second energization is immediately stopped and switched to third energization.

5. The starting method of the brushless motor according to claim 1, wherein
when the specific case is a case where the magnetic flux monitored by first energization changes to the negative side, further changes to the negative side by second energization but does not change to the positive side in mid-course, the energization is switched to third energization in accordance with the predetermined energizing sequence.

6. The starting method of a brushless motor according to claim 1, wherein
when the magnetic flux monitored is unchanged during each energization, energization is continued in the predetermined energizing sequence until the magnetic flux monitored changes.

7. The starting method of a brushless motor according to claim 2, wherein
when the magnetic flux monitored is unchanged during each energization, energization is continued in the predetermined energizing sequence until the magnetic flux monitored changes.

8. The starting method of a brushless motor according to claim 3, wherein
when the magnetic flux monitored is unchanged during each energization, energization is continued in the predetermined energizing sequence until the magnetic flux monitored changes.

9. The starting method of a brushless motor according to claim 4, wherein
when the magnetic flux monitored is unchanged during each energization, energization is continued in the predetermined energizing sequence until the magnetic flux monitored changes.

10. The starting method of a brushless motor according to claim 5, wherein
when the magnetic flux monitored is unchanged during each energization, energization is continued in the predetermined energizing sequence until the magnetic flux monitored changes.

11. A control device of a three-phase four-pole sensorless brushless motor including a stator having three-phase coils and a four-pole magnet rotor provided in correspondence with the stator, the device comprising:
a control circuit adapted to energize any two-phase coils of the three-phase coils in a predetermined energizing sequence for starting of the brushless motor; monitor magnetic flux generated in the other one-phase coil; and switch energization to the two-phase coils according to a specific case where the monitored magnetic flux changes to a positive or negative side and in mid-course further changes to an opposite side.

12. The starting method of a brushless motor according to claim 11, wherein
when the specific case is a case where the magnetic flux monitored by first energization changes to the negative side and in mid-course changes to the positive side, the control circuit immediately stops the first energization and switches the energization to sixth energization by skipping four energizations in the predetermined energizing sequence.

13. The starting method of a brushless motor according to claim 11, wherein
when the specific case is a case where the magnetic flux monitored by first energization changes to the positive side and in mid course further changes to the negative side, the control circuit immediately stops the first energization and switches the energization to second energization.

14. The starting method of a brushless motor according to claim 11, wherein
when the specific case is a case where the magnetic flux monitored by first energization changes to the positive side, and further changes to the negative side by second energization and in mid-course further changes to the positive side, the control circuit immediately stops the second energization and switches the energization to third energization.

15. The starting method of a brushless motor according to claim 11, wherein
when the specific case is a case where the magnetic flux monitored by first energization changes to the negative side, and further changes to the negative side by second energization but does not change to the positive side in mid-course, the control circuit switches the energization to third energization in accordance with the predetermined energizing sequence.

16. The starting method of a brushless motor according to claim 11, wherein
when the magnetic flux monitored during is unchanged each energization, the control circuit continues the energization in the predetermined sequence until the magnetic flux monitored changes.

17. The starting method of a brushless motor according to claim 12, wherein
when the magnetic flux monitored during is unchanged each energization, the control circuit continues the energization in the predetermined sequence until the magnetic flux monitored changes.

18. The starting method of a brushless motor according to claim 13, wherein
when the magnetic flux monitored during is unchanged each energization, the control circuit continues the energization in the predetermined sequence until the magnetic flux monitored changes.

19. The starting method of a brushless motor according to claim 14, wherein
when the magnetic flux monitored during is unchanged each energization, the control circuit continues the energization in the predetermined sequence until the magnetic flux monitored changes.

20. The starting method of a brushless motor according to claim 15, wherein
when the magnetic flux monitored during is unchanged each energization, the control circuit continues the energization in the predetermined sequence until the magnetic flux monitored changes.

21. A control device of a brushless motor including a stator having multiple-phase coils and a magnet rotor provided in correspondence with the stator, the device being arranged to: perform forced drive that forcibly energizes each phase coil by sequentially switching energization to each phase coil to rotate the magnet rotor; detect a position of the magnet rotor based on back-EMF voltage generated in each phase coil; and perform back-EMF drive for controlling energization to each phase coil based on a detected position, wherein
the device comprises a control circuit arranged to: first start the forced drive for starting of the brushless motor; perform the back-EMF drive when the position of the magnet rotor is detected based on the back-EMF voltage within a predetermined time from the start of the forced drive; stop the forced drive when the position of the magnet rotor is not detected based on the back-EMF voltage within the predetermined time from the start of the forced drive; and execute initial setting for controlling energization to each phase coil in order to set the magnet rotor in a initial position that facilitates the starting of the magnet rotor.
